(19) United States
(12) Patent Application Publication
(10) Pub. No.: US 2025/0322114 A1
(43) Pub. Date: Oct. 16, 2025

(54) VIRTUAL METHODOLOGY FOR ACTIVE FORCE CANCELLATION IN AUTOMOTIVE APPLICATION USING MASS IMBALANCE & CENTRIFUGAL FORCE GENERATION

(71) Applicant: FCA US LLC, Auburn Hills, MI (US)

(72) Inventors: Abhishek Paul, Auburn Hills, MI (US); Michael A Latcha, Rochester, MI (US)

(21) Appl. No.: 19/169,283

(22) Filed: Apr. 3, 2025

Related U.S. Application Data
(60) Provisional application No. 63/634,141, filed on Apr. 15, 2024.

(51) Int. Cl. G06F 30/17; G06F 30/20; G06F 111/10; G06F 119/14

(52) U.S. Cl. CPC G06F 30/17; G06F 30/20; G06F 2111/10; G06F 2119/14

(57) ABSTRACT

A method for simulating forces in a vehicle structure with an actuator includes providing a digital model of a vehicle structure for simulation based on finite element analysis, providing an actuator coupled to the vehicle structure at a first location, the actuator being a centrifugal force generator that includes a motor and an imbalance mass rotated by the motor to create a centrifugal force used as an offset force, and the actuator being arranged to apply the offset force to the vehicle structure, providing an excitation force of a first frequency to the vehicle structure, simulating activation of the actuator to provide the offset force on the vehicle structure at a second frequency that is offset from the first frequency, and determining with a simulation model an amplitude of a resulting force on the vehicle structure as a function of the excitation force and the offset force.

### REFERENCE TO RELATED APPLICATIONS

This application claims the benefit of U.S. Provisional Application Ser. No. 63/634,141 filed on Apr. 15, 2024, the entire contents of which is incorporated herein by reference in its entirety.

### FIELD

The present disclosure relates to a simulation of active force cancellation systems on vehicle structures.

### BACKGROUND

Various vibrations and forces are transmitted through vehicle components and can be noticeable by passengers of the vehicle. For example, as a vehicle travels over a bump or a pothole, forces are transmitted from the tires into the vehicle body either directly in case of unibody vehicles or through a frame in case of body on frame vehicles. In some cases, the frequency of forces from road inputs can align with the global bending or torsion frequency of the body or frame. This leads to resonance and amplifies the vibration amplitudes which is felt by the passengers in the vehicle.

Designing and testing systems to reduce forces and vibrations in a vehicle is expensive, especially if multiple different options and variations are to be tested. Further, providing dampers or actuators in some areas can increase or fail to decrease the transmission of forces in the vehicle, so understanding how a particular vehicle structure responds to different forces is very difficult.

### SUMMARY

In at least some implementations, a method for simulating forces in a vehicle structure with an actuator having an imbalance mass, includes, providing a digital model of a vehicle structure to be used in a simulation based on finite element analysis, providing an actuator coupled to the vehicle structure at a first location, the actuator being a centrifugal force generator that includes a motor and an imbalance mass rotated by the motor to create a centrifugal force used as an offset force, and the actuator being arranged to apply the offset force to the vehicle structure, providing an excitation force of a first frequency to the vehicle structure, simulating activation of the actuator to provide the offset force on the vehicle structure at a second frequency that is offset from the first frequency, and determining with a simulation model an amplitude of a resulting force on the vehicle structure as a function of the excitation force and the offset force.

In at least some implementations, the method also includes moving the actuator so the actuator is coupled to the vehicle structure at a second location and then repeating the steps of providing the excitation force, activating the actuator and determining the amplitude of the resulting force.

In at least some implementations, the method also includes changing one or both of the magnitude of the imbalance mass, a magnitude of an eccentricity of the mass or a rotational speed of the motor, and then repeating the steps of providing the excitation force, activating the actuator and determining the amplitude of the resulting force.

In at least some implementations, the motor is modeled as a DC motor and the model is of a multiple degree of freedom system where the vehicle structure includes multiple components that are interconnected, and the actuator is attached to one of the multiple components. In at least some implementations, the multiple components include two rails that are spaced apart from each other, and the vehicle structure includes multiple cross-members each connected to the two rails. In at least some implementations, the actuator is coupled to one of the cross members in the first location.

In at least some implementations, a controller is connected to the motor to control activation of the motor and a rotational speed of the motor. In at least some implementations, the controller controls the rotational speed of the motor to a predetermined speed selected to provide a predetermined frequency for the second frequency. In at least some implementations, the controller is modelled as a PID controller.

In at least some implementations, the model is based on the following equation of motion \dot{x}=Ax+Bu; y=Cx+Du, where A, B, C and D are matrices as follows:

$$A = [ \begin{matrix}0 & 1 \\ \frac{- k}{{m}_{1} + {m}_{2}} & \frac{- c}{{m}_{1} + {m}_{2}}\end{matrix} ] ; B = [ \begin{matrix}0 & 0 \\ \frac{1}{{m}_{1} + {m}_{2}} & \frac{1}{{m}_{1} + {m}_{2}}\end{matrix} ] ; \\ C = [ \begin{matrix}1 & 0 \\ 0 & 1 \\ \frac{- k}{{m}_{1} + {m}_{2}} & \frac{- c}{{m}_{1} + {m}_{2}} \\ 0 & 0\end{matrix} ] ; D = [ \begin{matrix}0 & 0 \\ 0 & 0 \\ \frac{1}{{m}_{1} + {m}_{2}} & \frac{1}{{m}_{1} + {m}_{2}} \\ 1 & 1\end{matrix} ] ,$$

and where m₁ is the mass of the vehicle structure, m₂ is the imbalance mass, k is a stiffness of a modeled spring acting on the vehicle structure, and c is the damping value acting on the vehicle structure.

In at least some implementations, a first input for the B matrix is the excitation force and a second input for the B matrix is the offset force.

In at least some implementations, the simulation model includes a switch that when off prevents the offset force from being applied and when the switch is on the offset force is applied to the vehicle structure.

In at least some implementations, the excitation force is sinusoidal. In at least some implementations, the sinusoidal excitation force has a constant frequency.

In at least some implementations, the vehicle structure includes two rails that are spaced apart from each other, and the vehicle structure includes multiple cross-members each connected to the two rails, and wherein the first location is defined by part of one of the cross-members, and the second location is defined by a different one of the cross-members in the second location.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a circuit for a DC motor;

FIG. 2 illustrates a model, single degree of freedom (SDOF) system;

FIG. 3 is a free body diagram of the system of FIG. 2;

FIG. 4 is a representation of a SDOF system in a simulation model;

FIG. 5 is a representation of a calculation of forces in a SDOF system with force cancelation;

FIG. 6 is a representation of a force cancelation using a PID controller in an ideal SDOF system;

FIG. 7 is a representation of a state space form of the SDOF system;

FIG. 8 is a representation of the system with a DC motor, centrifugal force generating (CFG) actuator and a frequency counter;

FIG. 9 is a graph showing a sinusoidal excitation force that is applied to the simulated model of the vehicle structure;

FIG. 10 is a graph showing the angular velocity of the motor as controlled by the controller;

FIG. 11 is a graph showing offset frequencies of the excitation force and an applied CFG force;

FIG. 12 is a graph showing resulting force amplitude and frequency;

FIG. 13 is a perspective view of a model of a vehicle structure, shown as a vehicle frame including multiple, interconnected components as part of a modeled multiple degree of freedom (MDOF) system;

FIG. 14 is a plan view of the frame;

FIG. 15 is a graph similar to FIG. 11 and showing the angular velocity of the motor as controlled by the controller, for an amplitude of about 19.7 Hz;

FIG. 16 is a graph of a simulated excitation force and a resulting force after activation of the CFG actuator, showing amplitude and frequency of the forces;

FIG. 17 is a plan view of the frame showing nine locations at which the actuator was modeled to be connected to the frame;

FIG. 18 is a chart showing amplitude reduction and stabilization time for simulations performed with the actuator at each of the nine locations of FIG. 17; and

FIG. 19 is a graph showing simulated excitation force and a resulting force after activation of the CFG actuator located at one of the nine locations at which the greatest force amplitude reduction was determined in the simulations.

### DETAILED DESCRIPTION

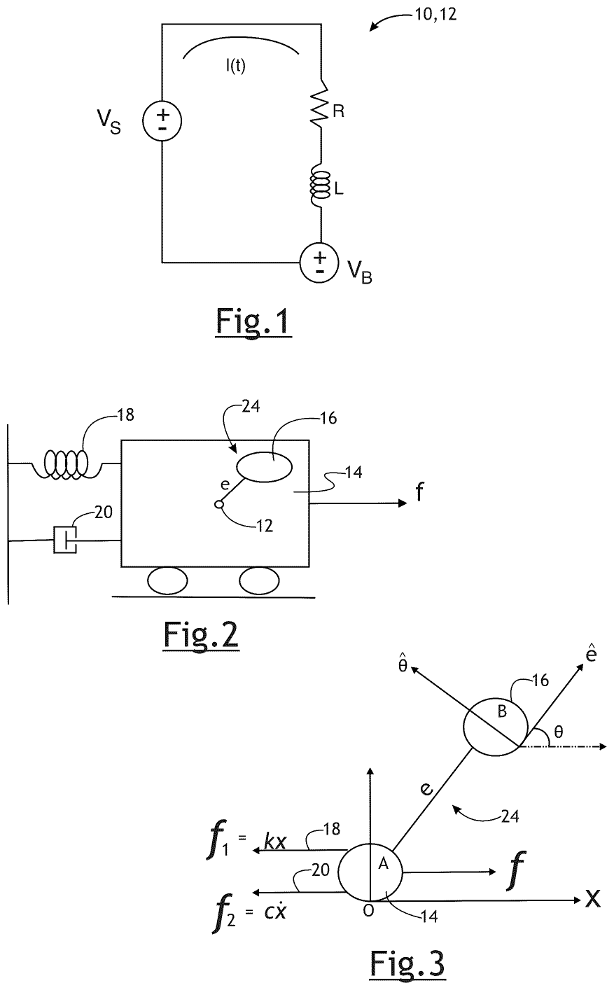

FIG. 1 shows a circuit 10 illustrating a DC motor 12 that has a rotating armature and an output shaft. The circuit contains current I (at a given time (t)), resistance R (e.g. armature resistance), inductance L, source voltage Vs and back electromagnetic force (EMF) voltage V_{B}. The below series of equations can be generated for an ideal motor (e.g. no friction).

$${V}_{s} = R * i ( t ) + L * \frac{d ( i ( t ) )}{dt} + {V}_{B} ; and \qquad ( 1 )$$

$${V}_{B} = ω * {K}_{B} , \qquad ( 2 )$$

where ω is the rotational velocity of the motor shaft, and K_{B} is a back EMF constant. Next,

$$T = J * \dot{ω} , \qquad ( 3 )$$

where T is the motor torque, J is the moment of inertia, and \dot{ω} is rotational acceleration. And

$$T = {K}_{T} * i ( t ) , \qquad ( 4 )$$

where K_{T} is motor torque constant.

From equations (3) and (4) above, it follows that:

$${K}_{T} * i ( t ) = J * \dot{ω} ( t ) . \qquad ( 5 )$$

From equations (1) and (2), it follows that:

$${V}_{s} = R * i ( t ) + L * \frac{d ( i ( t ) )}{dt} + ( {K}_{B} * ω ( t ) ) \qquad ( 6 )$$

From equation (5), we get:

$$\dot{ω} ( t ) = \frac{{K}_{T} * i ( t )}{J} , \qquad ( 7 )$$

and from equation (6),

$$\frac{d ( i ( t ) )}{dt} = \frac{{V}_{s} - R * i ( t ) - ( {K}_{B} * ω ( t ) )}{L} . \qquad ( 8 )$$

Integrating equations (7) and (8) above with an initial condition=0 over a given time period, gives:

$$ω ( t ) = ω ( 0 ) + \frac{{K}_{T}}{J} * \int ( i ( t ) ) dt , \qquad ( 9 )$$

and

$$i ( t ) = i ( 0 ) + \frac{1}{L} * \int \{ {V}_{s} - R * i ( t ) - ( {K}_{B} * ω ( t ) ) \} \qquad ( 10 )$$

$$ω ( 0 ) = 0 and i ( 0 ) = 0$$

From equation (10), a varying with time has been calculated for a given current varying with time, source voltage, resistance, inductance and constant K_{B}. However, the above set of equations represent a theoretical DC motor than a practical DC motor as friction is assumed to be 0.

Next, the equations for a more practical DC motor which includes friction have been derived.

$$T - ( {B}_{f} * ω ) = J * \dot{ω} \qquad ( 11 )$$

Where, B_{f} is the rotational friction damping coefficient.

From equations (4) and (11),

$${K}_{T} * i ( t ) - ( {B}_{f} * ω ) = J * \dot{ω} ( t ) \qquad ( 12 )$$

Assuming for now, K_{T}=K_{B}=K

Therefore equations (6) and (12) can be written as

$${V}_{s} = R * i ( t ) + L * \frac{d ( i ( t )}{dt} + ( K * ω ( t ) ) \qquad ( 13 )$$

$$K * i ( t ) - ( {B}_{f} * ω ( t ) ) = J * \dot{ω} ( t ) \qquad ( 14 )$$

Taking Laplace of equations (13) and (14)

$${V}_{s} - R * I ( s ) - L * s * I ( s ) - ( K * s * θ ( s ) ) = 0 \qquad ( 15 )$$

$$K * I ( s ) - ( {B}_{f} * s * θ ( s ) ) = J * {s}^{2} * θ ( s ) \qquad ( 16 )$$

I(s) and s*θ(s) are Laplace transform of i(t) and ω(t) respectively and initial conditions are considered to be 0.

From equation (16),

$$I ( s ) = \frac{( s * θ ( s ) ) * ( J * s + {B}_{f} )}{K} \qquad ( 17 )$$

Substituting equation (17) in equation (15) and since s*θ(s)=\dot{θ}(s),

$${V}_{s} = \{ \frac{( L * s + R ) * ( J * s + {B}_{f} )}{K} + K \} * \dot{θ} ( s ) \qquad ( 18 )$$

Which gives,

$$\frac{Vs}{\dot{θ} ( s )} = \{ \frac{( L * s + R ) * ( J * s + {B}_{f} )}{K} + K \} \qquad ( 19 )$$

This can be rewritten as,

$$\frac{\dot{θ} ( s )}{{V}_{s}} = \{ \frac{K}{( L * s + R ) * ( J * s + {B}_{f} ) + {K}^{2}} \} \qquad ( 20 )$$

Assuming i and ω as state variable,

$$\dot{θ} = K / J * i - {B}_{f} / J * ω = \frac{d ω}{dt} \qquad ( 21 )$$

And,

$$\frac{d i}{dt} = {V}_{s} / L - R / L * i - K / L * ω \qquad ( 22 )$$

This can be written in state space form as,

$$\frac{d}{dt} [ \begin{matrix}ω \\ i\end{matrix} ] = [ \begin{matrix}- {B}_{f} / J & K / J \\ - K / L & - R / L\end{matrix} ] * \{ \begin{matrix}ω \\ i\end{matrix} \} + [ \begin{matrix}0 \\ 1 / L\end{matrix} ] * {V}_{s} \qquad ( 23 )$$

Referring in more detail to the drawings, FIG. 2 illustrates a system with an object 14 having mass m₁ acted on by unbalanced mass 16 (called herein an “imbalance mass”) having mass m₂. The imbalance mass 16 is provided off set from a center of mass of object 14, at a distance denoted by eccentricity (e) in FIG. 2. The motor 12 may be used to move the imbalance mass 16 relative to the object 14. In this system, the object 14 also is acted upon by a spring 18 having spring rate or stiffness k, and a damper 20 providing a damping force c on object 14. FIG. 3 illustrates a free body diagram of the system. From this system an equation of motion can be derived.

A single degree of freedom (SDOF) system consists of lumped mass m₁ (e.g. object 14), spring 18 with stiffness k and damper 20. Force f is applied to the right-hand side of the system and an equation of motion can be defined, and acceleration, velocity and displacement can be computed as follows:

$$m \ddot{x} ( t ) + c \dot{x} ( t ) + k x ( t ) = f ( t ) , \qquad ( 24 )$$

which gives,

$$\ddot{x} ( t ) = ( f ( t ) - c \dot{x} ( t ) - k x ( t ) ) / m , \qquad ( 25 )$$

where \ddot{x}(t) is the acceleration, \dot{x}(t) is the velocity and x(t) is the displacement of the lumped mass under forced excitation f(t). Applying Newton's second law to the SDOF system with mass imbalance m₂,

$$\sum F = {m}_{2} * \vec{{a}_{B / O}} = {m}_{2} * \vec{{a}_{A / O}} + {m}_{2} * \vec{{a}_{B / A}} \qquad ( 26 )$$

$$\text{=>} {m}_{2} \ddot{x} + {m}_{2} [ ( \ddot{e} - e {\dot{θ}}^{2} ) ê + ( e \ddot{θ} + 2 \dot{e} \dot{θ} ) \hat{θ} ] \qquad ( 27 )$$

where ė=ë=0 since the eccentricity distance/arm length does not change over time and \dot{θ}=\dot{ω} which is a constant.

$$\text{=>} {m}_{2} \ddot{x} \hat{ι} - {m}_{2} e {\dot{θ}}^{2} \hat{e} \text{=>} \hat{e} = Cos ω t \hat{ι} + Sin ω t \hat{j} \qquad ( 28 )$$

$$\text{=>} {m}_{2} \ddot{x} \hat{ι} - {m}_{2} e {ω}^{2} ( Cos ω t \hat{ι} + Sin ω t \hat{j} ) + {m}_{2} g \hat{j} \qquad ( 29 )$$

Resolving in X and Y components,

$$\sum {F}_{{m}_{{2}_{x}}} = {m}_{2} \ddot{x} - {m}_{2} e {ω}^{2} Cos ω t = \sum {F}_{{m}_{{1}_{x}}} \qquad ( 30 )$$

$$\sum {F}_{{m}_{{2}_{y}}} = - {m}_{2} e {ω}^{2} Sin ω t + {m}_{2} g \qquad ( 31 )$$

In at least some implementations, forces in the X direction only are considered and this becomes:

$$\sum {F}_{{m}_{{1}_{x}}} = {m}_{1} \ddot{x} = - \sum {F}_{{m}_{{2}_{x}}} = - {m}_{2} \ddot{x} + {m}_{2} e {ω}^{2} Cos ω t \qquad ( 32 )$$

Which gives,

$$( {m}_{1} + {m}_{2} ) \ddot{x} = {m}_{2} e {ω}^{2} Cos ω t \qquad ( 33 )$$

Considering the forces due to the damper and spring, equation (33) can be rewritten as:

$$( {m}_{1} + {m}_{2} ) \ddot{x} = {m}_{2} e {ω}^{2} Cos ω t - k x - c \dot{x} \qquad ( 34 )$$

Here, m₂eω² Cos ωt is the centrifugal force the direction of which depends on the rotational direction of the imbalanced mass m₂. The centrifugal force is used to provide counter force to the external force on the object 14 to reduce acceleration, velocity, and displacement of the system.

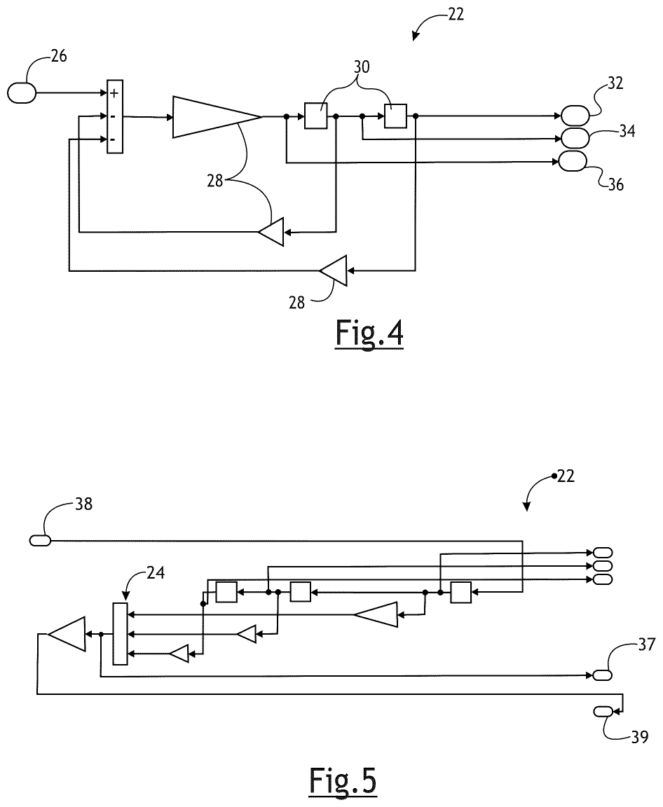

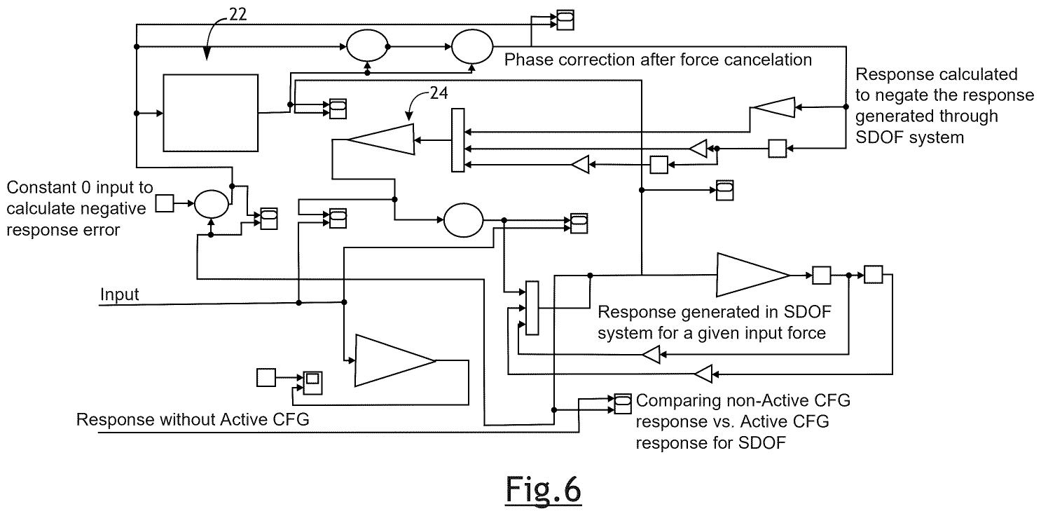

The equations and findings previously noted are used to define, at least in part, a virtual simulation model consisting of a SDOF system under external force excitation and with a DC motor 12, imbalance mass 16 and a controller 22, such as a PID controller, as a force actuator 24 used to cancel the external force in real time. FIG. 4 shows a single degree of freedom representation in a simulation model, showing a source 26 of excitation force, the controller (with representative amplifiers 28 and integrators 30 shown) to provide displacement, velocity and acceleration outputs 32, 34, 36. In general, to cancel an external force excitation, an equal and opposite force is introduced into the system. FIG. 5 shows calculation of the equal and opposite force based on the output response from the single degree of freedom system which is fed back into the system to cancel the initial force. From the model of FIG. 4, an acceleration input is provided at 38, and the offset/cancellation force output 37 and motor speed 39 to achieve the force output are determined by the controller 22, with a phase lag error between the excitation force and cancellation force being managed by the controller 22. This is a simplistic representation of force cancellation and is shown in FIG. 6.

In this model, the actuator 24 provides centrifugal force generation using an imbalance mass 16. The difference in response output measured in terms of acceleration when the actuator 24 is switched off, and the response output when the actuator 24 is switched on, is compared. As compared to the model described, this model uses a DC motor 12 to generate an angular velocity (e.g. rotational speed) used by the centrifugal force actuator 24 to generate the cancellation force and create a closed loop system which helps to reduce the response output for a given force excitation to the SDOF system. The SDOF system, with the mass imbalance in state space form, can be modeled as follows.

Here, we assume the same system described in FIG. 2 for which the equation of motion is described in equation (34), and so in state space form:

$$\dot{x} = A x + B u ; y = C x + D u \qquad ( 35 )$$

where,

$$A = [ \begin{matrix}0 & 1 \\ \frac{- k}{{m}_{1} + {m}_{2}} & \frac{- c}{{m}_{1} + {m}_{2}}\end{matrix} ] ; B = [ \begin{matrix}0 & 0 \\ \frac{1}{{m}_{1} + {m}_{2}} & \frac{1}{{m}_{1} + {m}_{2}}\end{matrix} ] ; C = [ \begin{matrix}1 & 0 \\ 0 & 1 \\ \frac{- k}{{m}_{1} + {m}_{2}} & \frac{- c}{{m}_{1} + {m}_{2}} \\ 0 & 0\end{matrix} ] ; D = [ \begin{matrix}0 & 0 \\ 0 & 0 \\ \frac{1}{{m}_{1} + {m}_{2}} & \frac{1}{{m}_{1} + {m}_{2}} \\ 1 & 1\end{matrix} ] . \qquad ( 36 )$$

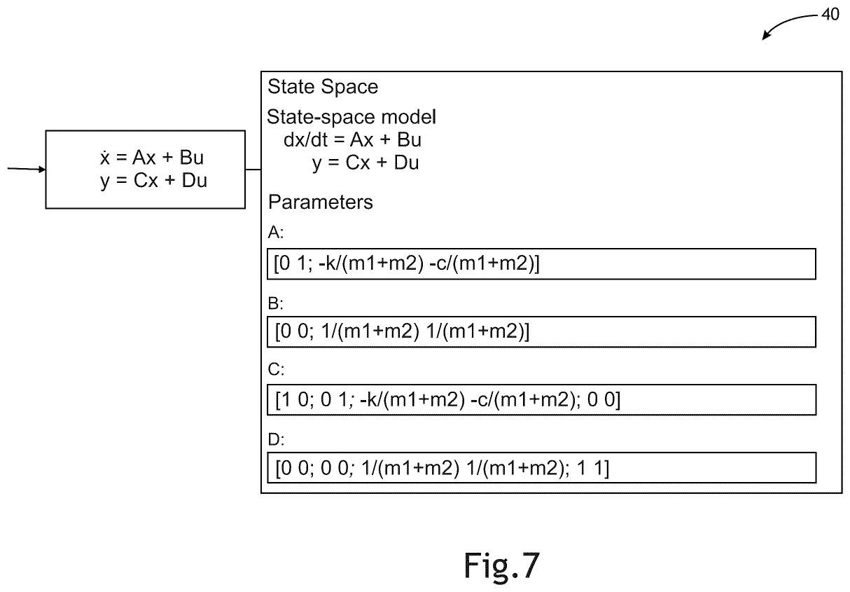

As shown in FIG. 7, this can be represented in a simulation model using the state space block 40 and filling up four matrices (labeled A, B, C and D) from equation (36), and with state vector x, output vector y and input/control vector u.

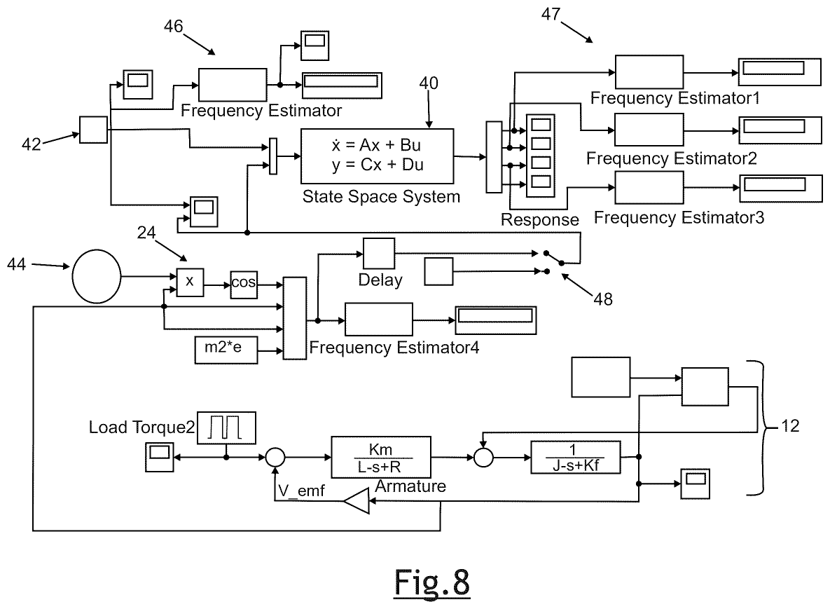

Next, an input 42 to the system is defined to represent the external excitation of the force into the SDOF system defined in the state space. Referencing fundamentals of a state space system 40 defined in equation (36), the B matrix is a 2×2 matrix which means that 2 inputs to the system are required. As shown in FIG. 8, of the 2 inputs, the first input 42 is the external excitation force, and the second input 44 is the actuation force coming from the centrifugal force generator. The actuation force is the cancellation force used to cancel the external force and reduce the response of the system.

To test the model, the second input 44 can be kept at zero, and the state space system 40 can be modeled/tested with the first input 42, the external excitation force, having a sinusoidal input of 10 Hz and amplitude of 1000 N. Further for this test, mass m₁=200 kgs, m₂=0.2 kgs, k=1000 N/mm and c=3.8 Ns/mm. After validating the system, a block is defined to measure the frequency of excitation and a DC motor 12, as described herein. In addition, an actuator 24 can be defined that takes the angular velocity generated from the DC motor output shaft to generate a force that becomes the cancellation force. The PID controller 22 for the DC motor 12 will control the angular velocity of the motor shaft based on input voltage and load torque.

While a PID controller 22 could have been used directly to control the output response from the system and generate a signal to cancel the excitation, that would not serve the practical purpose as in reality an actuator 24 (e.g. external motor 12 with an imbalance mass 16) is needed to generate the force that can reduce the response from the system. FIG. 8 shows the system with the motor 12/CFG actuator 24 and frequency counter 46 added to the system and providing a system response at 47.

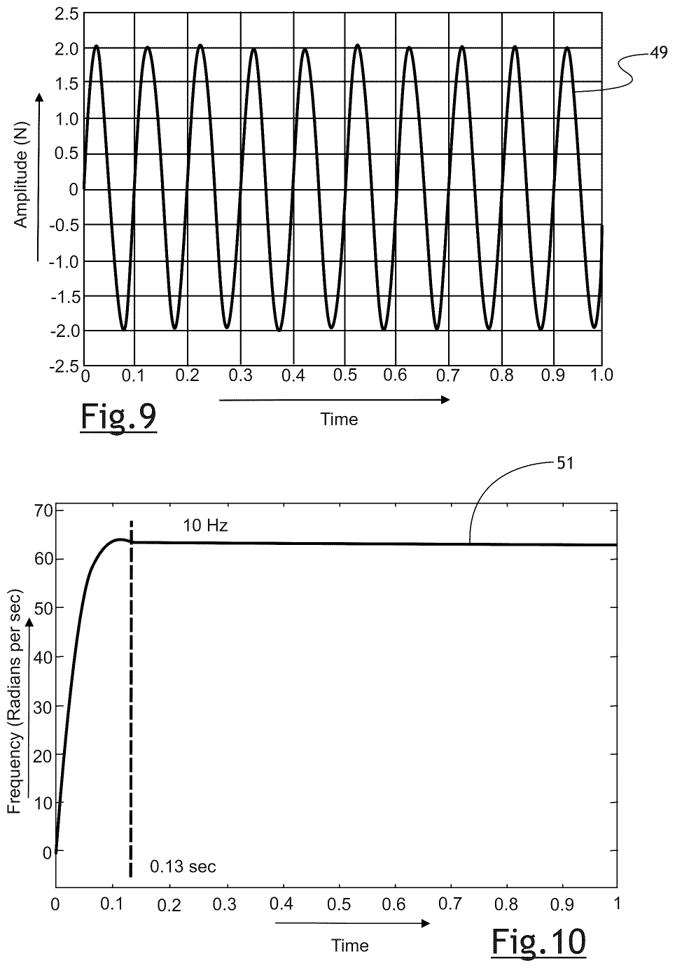

The model may also include a switch 48 to see the response with and without the cancellation force coming through the CFG actuator 24. For testing/modeling, an external force excitation has been added in form of a sinusoidal wave 49 of amplitude of 1 kN and a frequency of 10 Hz, as shown in FIG. 9. The simulation was run for 1 second and, for a given motor 12 the torque is proportional to the current provided to the motor 12, and the back emf is proportional to the motor speed (e.g. rpm). A standard DC motor 12 was used with the following numerical values of the coefficients. L=0.5 Henrys, R=2 Ohms, Kf=0.2 Nms, Kb=0.1, J=0.02 kgm2/s2 and Km=0.1.

In the test, the switch is turned on at 0.07 seconds and the actuator 24 supplies the cancellation force generated from the angular velocity achieved for the DC motor 12 used. The waveform 51 in FIG. 10 shows the time taken by the DC motor 12 to achieve 10 Hz speed which is equivalent to 60 revolutions per second (rps). As shown in FIG. 10, it took about 0.13 seconds to achieve a steady state of the motor speed. The maximum centrifugal force generated for the given mass and eccentricity, and this angular velocity, is about 1 kN. Due to the time taken by the DC motor 12 to achieve steady state, there is a slight difference in frequency of the CFG force and the external force and since this is a transient analysis, some cancellation to reduce the acceleration response is expected but not completely zero, and the force reduction from the force output through the system has also been checked.

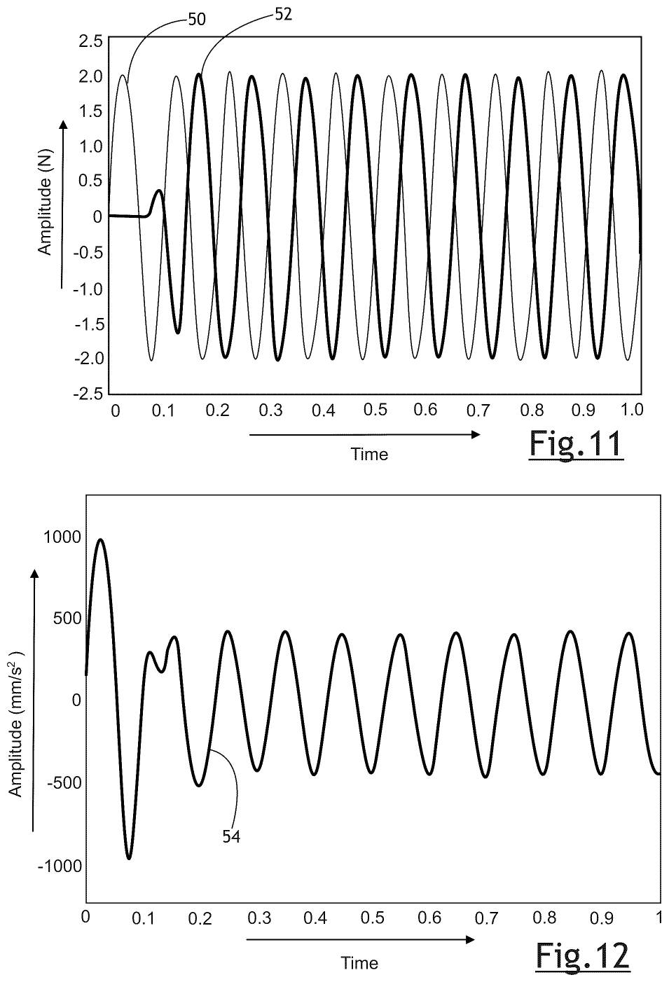

FIG. 11 shows a comparison of the external force, shown by wave 50, with the CFG cancelation force, shown by wave 52, which starts its maximum amplitude at about 0.13 seconds as it is proportional to the time taken by the DC motor 12 to reach its steady state velocity of the shaft. FIG. 12 shows the acceleration response when the CFG actuator 24 is switched on. A reduction in the response output of greater than 50% (by amplitude) and the force is shown in wave 54.

For complete cancellation the time taken by the DC motor 12 to achieve the steady state needs to be minimized to reduce the difference in frequency between the excitation force and the CFG force. Theoretically, if the frequency is identical then the cancellation will be 100% but, there will be some loss due to time lag required for achieving steady state of the motor velocity. This can be optimized further to improve performance by tuning the PID controller 22, as desired.

The above testing was for a SDOF, and can be applied to a system having Multiple Degrees of Freedom, a so-called MDOF system. In the example described below, a truck frame 60 is modeled using finite elements, scripting and finite element modeling (FEM) to simulate canceling of responses for this truck frame 60. The modeled frame 60 includes a pair of laterally spaced apart and longitudinally extending rails 62 and multiple cross-members 64 extending laterally between and connected to each rail 62.

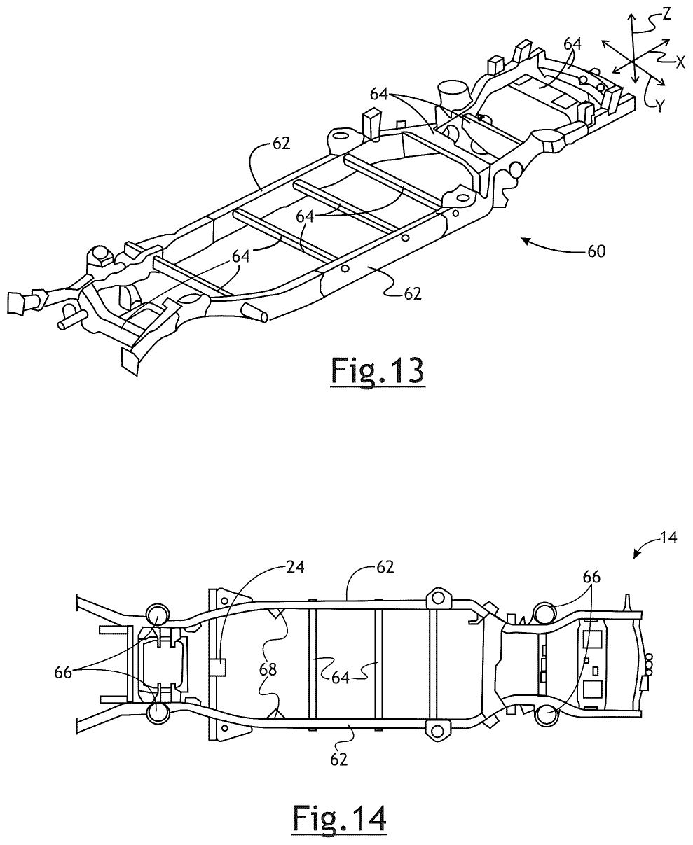

The first step in defining the MDOF system was modeling a finite element model of a 169-inch wheelbase truck frame 60, as shown in FIG. 13. After modeling, the next step was to run the normal mode analysis to determine the first bending mode of the frame 60. In testing, an issue was identified in this vehicle which was a vertical shake issue which has been observed at around 8.5 Hz at a full vehicle level. This is primarily due to high amplitudes above the target due to the vertical bending mode of the full vehicle, which at frame level, is noted to be at around 19.7 Hz. So an objective in modeling was to reduce the output acceleration amplitude at the bending node of the first bending mode of the frame 60. To work with this problem in a less computationally expensive manner, the frame model was used without other components of the vehicle.

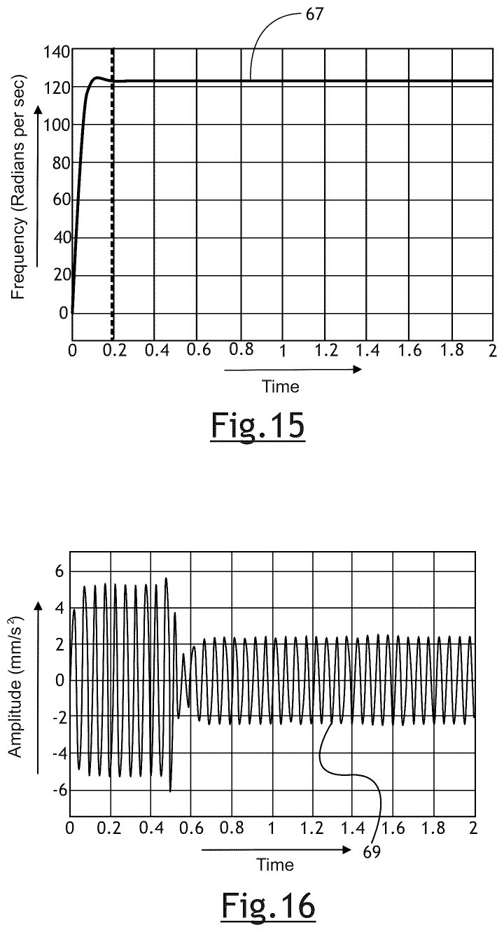

In the example used, the FEM had over 150,000 elements, and the total mass of the frame 60 is about 295 kgs. To induce a bending mode, the frame 60 was excited at the suspension locations (e.g. points 66) in the Z-direction. The CFG actuator 24 was placed at or near the center node of a frame cross member 64, as shown in FIG. 14, which also shows response output measurement locations 68. To reduce computational time, the model was converted to a modal domain, and the mass, stiffness, damping and force matrices were extracted using a Direct Matrix Abstraction Program (DMAP) in FEM software. This was then represented in state space format and modal superposition was used to compute the response with the active cancellation switched off and then switched on at about 0.4 seconds. In one example, the simulation was run for 2 seconds. The waveform 67 in FIG. 15 shows the time taken by the PID controller 22 to control the required angular velocity and stabilize it. The waveform 69 in FIG. 16 shows the amplitude reduction once the active cancellation is switched on.

In this example, a sinusoidal excitation force of 10 kN was introduced to the system to excite the truck frame 60 at the bending frequency of 19.7 Hz. The imbalance mass 16 modeled was 2 kgs, and the eccentricity used was 250 mm. FIG. 16 also depicts when the active CFG tool was initially off (e.g. the switch was in the off state), the acceleration output is high and after it is switched on at about 0.4 seconds, it then took about 0.2 seconds for the PID controller 22 to stabilize the angular velocity of the output shaft in the DC motor 12. Following this an amplitude reduction of about 55% was observed in the acceleration response output.

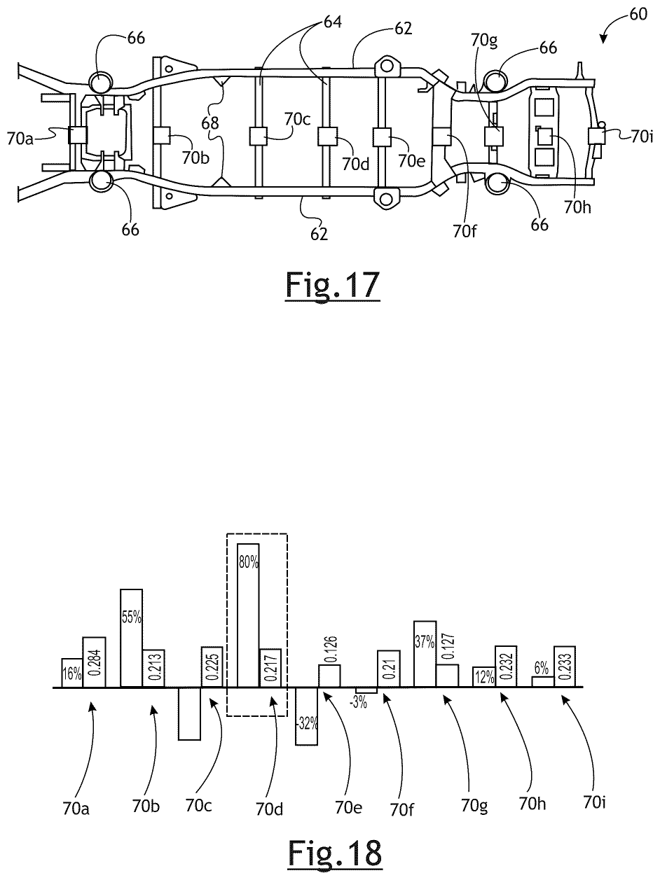

Following this, a study was conducted to identify an optimized location of the actuator 24 that would provide an improved or maximum amplitude reduction. To identify this location, multiple locations were selected, based on the packaging constraints of the frame 60 and the full vehicle. FIG. 17 shows nine locations 70a-70i that were initially identified, one on each of the frame cross-members 64. The reduced mass, stiffness and damping matrices were extracted from FEM using DMAP for all the nine locations 70a-70i and the state space system representing each of the nine iterations were created using scripting.

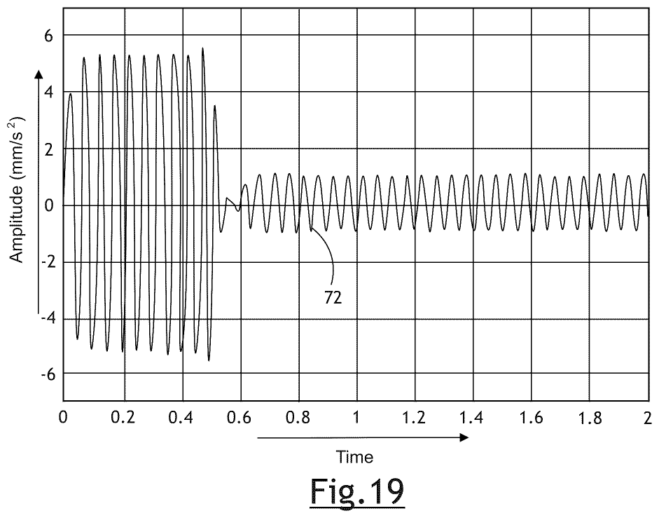

FIG. 18 shows, for the nine locations 70a-70i, the response amplitude improvement by the bars on the left of each and the stabilization time for the controller 22 by the bars on the right side of each. The waveform 72 in FIG. 19 shows the acceleration output reduction in location four 70d which had the greatest improvement in peak amplitude. In addition, and as shown in FIG. 18, it was determined that placing the ACFG actuator 24 in any location on the frame 60 may not show positive reduction, and based on the mode shape and the load path may result in negatively impacting the performance, as shown by a negative improvement in peak amplitude in locations three 70c, five 70e and six 70f. Also, there is variation in the time taken by the controller 22 to stabilize the angular velocity of the DC motor 12 to compute the cancellation force from the actuator 24.

As shown in FIG. 18, the least time taken for stabilization was at location six 70f but in that location the actuator 24 negatively impacted the performance. The next best solution from the stabilization/time perspective was for location seven 70g which showed about 37% amplitude reduction. In at least some implementations, the preferred solution may result from a balance between the amplitude reduction improvement and the time taken to get this improvement. The model created can assist the vehicle engineers in planning the design of the structure with more accurate ACFG, and provide information related to how much improvement can be expected, with a virtual simulation rather than requiring actual component testing. Additionally, results can be reviewed for different imbalance mass 16, eccentricities, frame locations, and DC motor properties, prior to constructing a physical prototype.

With the modelling of mass imbalance and DC motors in a SDOF system, a virtual tool is provided for determining improved active force cancellation using CFG principles. The model can be applied to a wide variety of components and structures to enable efficient simulations and more accurate results for force cancellation in even complex structures.

In at least some implementations, improved force cancellation can be achieved when the frequency of the excitation force matches the angular velocity of the DC motor shaft. The model additionally showed that minor phase lag between the excitation and cancellation forces results in cyclical reduction and amplification of the final output. In view of this, an additional inclusion of error correction can be provided for consistent reduction without requiring amplification of the final actuator output. The study also concluded that for a given imbalance mass 16 and eccentricity, which are limited due to product cost, weight and size requirements, significant but not total reduction of final output response can be achieved.

A finite element model of a truck frame 60 has been built and reduced in modal domain and represented in simulation model by extracting the mass, stiffness, damping, eigenvalue, displacement and force matrices using DMAP from FEM and scripting. It was observed that solving the system of equations for the finite element model in the physical domain is computationally very expensive as the matrices can be huge, therefore reduction of the model using eigenvalues in modal domain helps to reduce the computation time significantly without compromising the accuracy of the solution. Successful demonstration of amplitude reduction for a truck frame 60 at the bending frequency has been shown using the Active CFG actuator 24 and modal super position principle. This helped in identification of the imbalance mass 16 and designing the physical prototype required for achieving a desired magnitude or reduction in the output response for the vertical shake issue presented in the vehicle.

Finally, an optimum location for placing the ACFG actuator 24 can be determined, based, for example, on the percentage of amplitude reduction improvement (e.g. maximum amplitude) and time taken for the controller 22 to stabilize the angular velocity of the motor shaft for actuation for a given imbalance mass 16, eccentricity and DC motor properties. This enables improved design of the fixture and identification of the best package and manufacturing feasibility for development on a physical prototype of the frame 60.

In some cases, the forcing frequency of a road input (e.g. bump, pothole or other discontinuity) excites the suspension hop or tramp modes in a vehicle which may align with the global bending or torsion frequency of the vehicle body or frame 60. This leads to resonance and can amplify the vibration amplitudes which makes it more noticeable and objectionable to passengers in the vehicle. The simulation methods described herein are specifically described with regard to a field issue on a body on frame truck where the suspension hop mode aligns with the bending frequency of the frame 60 resulting in resonance and a vertical shake issue. This degrades the ride performance and causes discomfort to the driver and the passengers in vehicle. While this is one useful example, the methods of simulating excitation forces and offset forces with a centrifugal force generator can be applied to other vehicles, with variables changed in different simulations as desired.

With the controller 22/control system integrated into the finite element modelling, the virtual tool can be used as a directional/predictive tool to aid in vehicle product development with improved suppression of vibrations in automotive structures. The model includes a centrifugal force generation with an imbalanced mass, and provides information to enable identification of the percentage of amplitude reduction of an excitation force for a given imbalance weight and eccentricity, and at various locations on the vehicle structure. This knowledge helps automotive engineers to determine a packaging scope of an active Centrifugal Force Generation (CFG) system, including the weight penalty to the program and the magnitude or percentage improvement in ride performance. The real-world working principles and characteristics of DC motors can be included in the model, as noted herein, rather than considering ideal motors without friction or time delays. Use of real-world operational characteristics of the DC motor 12 improves the accuracy of the simulations compared to an actual actuator on an actual or prototype vehicle structure.

What is claimed is:

1. A method for simulating forces in a vehicle structure with an actuator having an imbalance mass, comprising:
providing a digital model of a vehicle structure to be used in a simulation based on finite element analysis;
providing an actuator coupled to the vehicle structure at a first location, the actuator being a centrifugal force generator that includes a motor and an imbalance mass rotated by the motor to create a centrifugal force used as an offset force, and the actuator being arranged to apply the offset force to the vehicle structure;
providing an excitation force of a first frequency to the vehicle structure;
simulating activation of the actuator to provide the offset force on the vehicle structure at a second frequency that is offset from the first frequency; and
determining with a simulation model an amplitude of a resulting force on the vehicle structure as a function of the excitation force and the offset force.

2. The method of claim 1 which also includes moving the actuator so the actuator is coupled to the vehicle structure at a second location and then repeating the steps of providing the excitation force, activating the actuator and determining the amplitude of the resulting force.

3. The method of claim 1 which also includes changing one or both of the magnitude of the imbalance mass, a magnitude of an eccentricity of the mass or a rotational speed of the motor, and then repeating the steps of providing the excitation force, activating the actuator and determining the amplitude of the resulting force.

4. The method of claim 1 wherein the motor is modeled as a DC motor and the model is of a multiple degree of freedom system where the vehicle structure includes multiple components that are interconnected, and the actuator is attached to one of the multiple components.

5. The method of claim 1 wherein a controller is connected to the motor to control activation of the motor and a rotational speed of the motor.

6. The method of claim 1 wherein the model is based on the following equation of motion \dot{x}=Ax+Bu; y=Cx+Du, where A, B, C and D are matrices as follows:
$$A = [ \begin{matrix}0 & 1 \\ \frac{- k}{{m}_{1} + {m}_{2}} & \frac{- c}{{m}_{1} + {m}_{2}}\end{matrix} ] ; B = [ \begin{matrix}0 & 0 \\ \frac{1}{{m}_{1} + {m}_{2}} & \frac{1}{{m}_{1} + {m}_{2}}\end{matrix} ] ; C = [ \begin{matrix}1 & 0 \\ 0 & 1 \\ \frac{- k}{{m}_{1} + {m}_{2}} & \frac{- c}{{m}_{1} + {m}_{2}} \\ 0 & 0\end{matrix} ] ; D = [ \begin{matrix}0 & 0 \\ 0 & 0 \\ \frac{1}{{m}_{1} + {m}_{2}} & \frac{1}{{m}_{1} + {m}_{2}} \\ 1 & 1\end{matrix} ] ,$$
and where m₁ is the mass of the vehicle structure, m₂ is the imbalance mass, k is a stiffness of a modeled spring acting on the vehicle structure, and c is the damping value acting on the vehicle structure.

7. The method of claim 6 wherein a first input for the B matrix is the excitation force and a second input for the B matrix is the offset force.

8. The method of claim 1 wherein the simulation model includes a switch that when off prevents the offset force from being applied and when the switch is on the offset force is applied to the vehicle structure.

9. The method of claim 5 wherein the controller controls the rotational speed of the motor to a predetermined speed selected to provide a predetermined frequency for the second frequency.

10. The method of claim 9 wherein the controller is modelled as a PID controller.

11. The method of claim 1 wherein the excitation force is sinusoidal.

12. The method of claim 11 wherein the sinusoidal excitation force has a constant frequency.

13. The method of claim 4 wherein the multiple components include two rails that are spaced apart from each other, and the vehicle structure includes multiple cross-members each connected to the two rails.

14. The method of claim 13 wherein the actuator is coupled to one of the cross members in the first location.

15. The method of claim 2 wherein the vehicle structure includes two rails that are spaced apart from each other, and the vehicle structure includes multiple cross-members each connected to the two rails, and wherein the first location is defined by part of one of the cross-members, and the second location is defined by a different one of the cross-members in the second location.
